(19) United States
(12) Patent Application Publication
(10) Pub. No.: US 2011/0044248 A1
(43) Pub. Date: Feb. 24, 2011

(54) RELIABLE INTER-RADIO ACCESS TECHNOLOGY CORE NETWORK TUNNEL

(75) Inventors: Shivanarayana Saranu, Hyderabad (IN); Masakazu Shirota, Yokohama-shi (JP); Kurt W. Otte, Erie, CO (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/857,610

(22) Filed: Aug. 17, 2010

Related U.S. Application Data
(60) Provisional application No. 61/234,951, filed on Aug. 18, 2009.

(51) Int. Cl. H04W 40/00

(52) U.S. Cl. 370/328

(57) ABSTRACT

A method of a mobile switching center includes determining if a message belongs to a first set of messages or a second set of messages, filtering the message when the message belongs to the first set of messages, and sending the message when the message belongs to the second set of messages. A method of an interworking solution includes receiving a message from an apparatus, determining if the message belongs to a first set of messages or a second set of messages, and discarding the message when the message belongs to the first set of messages. The first set of messages are 1× native messages unsupported for tunneling to a user equipment and the second set of messages are 1× native messages supported for tunneling to the user equipment for circuit switch fallback procedures.

### CROSS-REFERENCE TO RELATED APPLICATION(S)

This application claims the benefit of U.S. Provisional Application Ser. No. 61/234,951, entitled “Reliable Inter-Radio Access Technology Core Network Tunnel” and filed on Aug. 18, 2009, which is expressly incorporated by reference herein in its entirety.

### BACKGROUND

1. Field of the Invention

The present disclosure relates generally to communication systems, and more particularly, to a reliable inter-radio access technology core network tunnel.

2. Relevant Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

In an aspect of the disclosure, a method, a computer program product, and a mobile switching center are provided in which it is determined if a message belongs to a first set of messages or a second set of messages, the message is filtered when the message belongs to the first set of messages, and the message is sent when the message belongs to the second set of messages.

In an aspect of the disclosure, a method, a computer program product, and an interworking solution are provided in which a message is received from an apparatus, it is determined if the message belongs to a first set of messages or a second set of messages, and the message is discarded when the message belongs to the first set of messages.

In an aspect of the disclosure, a method, a computer program product, and a mobile switching center are provided in which a message is sent to an apparatus. The message belongs to one of a first set of messages or a second set of messages. In addition, a second message is sent when the message belongs to the second set of messages and a response is not received regarding the sent message. Furthermore, the method, computer program product, and mobile switching center abstains from sending the second message when the message belongs to the first set of messages and a response is not received regarding the sent message.

In an aspect of the disclosure, a method, a computer program product, and an interworking solution are provided in which any message is received from a mobile switching center, the message is processed for tunneling to a user equipment for a circuit switched fallback procedure.

In an aspect of the disclosure, a method, a computer program product, and a mobile switching center are provided in which it is determined to send a message to an interworking solution regarding a circuit switched fallback procedure. In addition, the message is sent on an interface different from an A1 interface.

### BRIEF DESCRIPTION OF THE DRAWINGS

FIG. 1 is a diagram illustrating an example of a hardware implementation for an apparatus employing a processing system.

FIG. 2 is a diagram illustrating an example of a network architecture.

FIG. 3 is a diagram illustrating an example of an access network.

FIG. 4 is a diagram illustrating an example of a frame structure for use in an access network.

FIG. 5 shows an exemplary format for the UL in LTE.

FIG. 6 is a diagram illustrating an example of a radio protocol architecture for the user and control plane.

FIG. 7 is a diagram illustrating an example of an evolved Node B and user equipment in an access network.

FIG. 8 is a reference architecture for circuit switched fallback to 1×Radio Transmission Technology circuit switched.

FIG. 9 is an illustration showing the sets of messages for 1×native operation and messages for enhanced 1×circuit switched fallback operation.

FIG. 10 is an exemplary architecture for circuit switched fallback to 1×Radio Transmission Technology circuit switched.

FIG. 11 is a flow chart of a first method of wireless communication.

FIG. 12 is a conceptual block diagram illustrating the functionality of a first exemplary apparatus.

FIG. 13 is a flow chart of a second method of wireless communication.

FIG. 14 is a conceptual block diagram illustrating the functionality of a second exemplary apparatus.

FIG. 15 is a flow chart of a third method of wireless communication.

FIG. 16 is a conceptual block diagram illustrating the functionality of a third exemplary apparatus.

FIG. 17 is a flow chart of a fourth method of wireless communication.

FIG. 18 is a conceptual block diagram illustrating the functionality of a fourth exemplary apparatus.

FIG. 19 is a flow chart of a fifth method of wireless communication.

FIG. 20 is a conceptual block diagram illustrating the functionality of a fifth exemplary apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawing by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

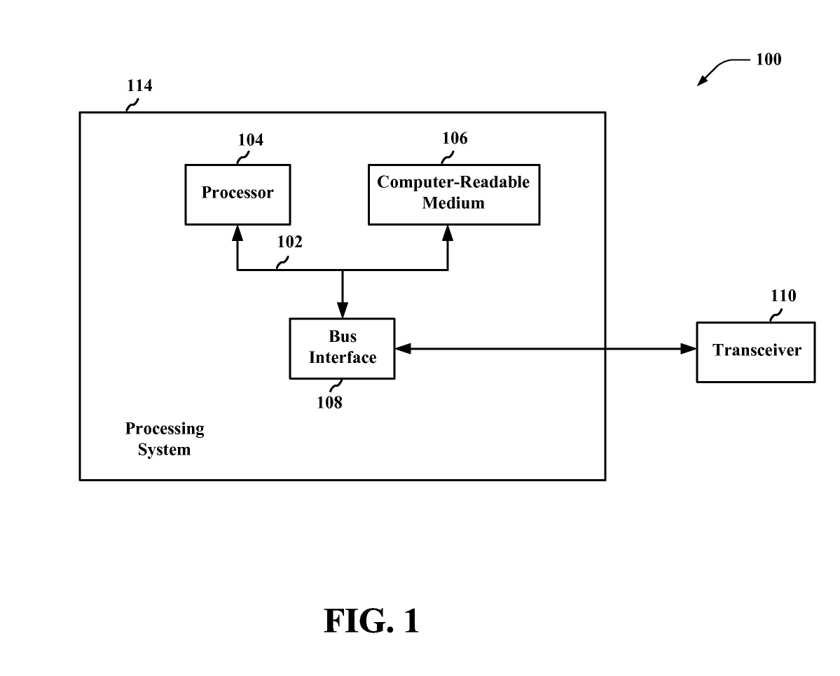

FIG. 1 is a conceptual diagram illustrating an example of a hardware implementation for an apparatus 100 employing a processing system 114. In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors, represented generally by the processor 104, and computer-readable media, represented generally by the computer-readable medium 106. The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatus over a transmission medium. The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software.

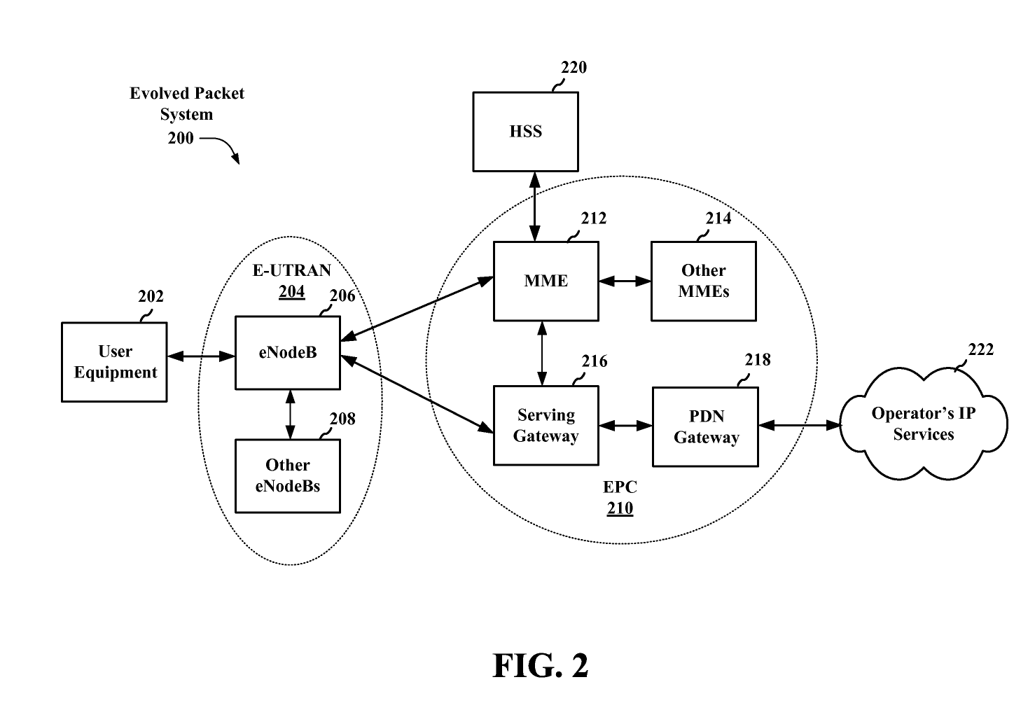

FIG. 2 is a diagram illustrating an LTE network architecture 200 employing various apparatuses 100 (See FIG. 1). The LTE network architecture 200 may be referred to as an Evolved Packet System (EPS) 200. The EPS 200 may include one or more user equipment (UE) 202, an Evolved UMTS Terrestrial Radio Access Network (E-UTRAN) 204, an Evolved Packet Core (EPC) 210, a Home Subscriber Server (HSS) 220, and an Operator's IP Services 222. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 206 and other eNBs 208. The eNB 206 provides user and control plane protocol terminations toward the UE 202. The eNB 206 may be connected to the other eNBs 208 via an X2 interface (i.e., backhaul). The eNB 206 may also be referred to by those skilled in the art as a base station, a base transceiver station, a radio base station, a radio transceiver, a transceiver function, a basic service set (BSS), an extended service set (ESS), or some other suitable terminology. The eNB 206 provides an access point to the EPC 210 for a UE 202. Examples of UEs 202 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 202 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 206 is connected by an S1 interface to the EPC 210. The EPC 210 includes a Mobility Management Entity (MME) 212, other MMEs 214, a Serving Gateway 216, and a Packet Data Network (PDN) Gateway 218. The MME 212 is the control node that processes the signaling between the UE 202 and the EPC 210. Generally, the MME 212 provides bearer and connection management. All user IP packets are transferred through the Serving Gateway 216, which itself is connected to the PDN Gateway 218. The PDN Gateway 218 provides UE IP address allocation as well as other functions. The PDN Gateway 218 is connected to the Operator's IP Services 222. The Operator's IP Services 222 include the Internet, the Intranet, an IP Multimedia Subsystem (IMS), and a PS Streaming Service (PSS).

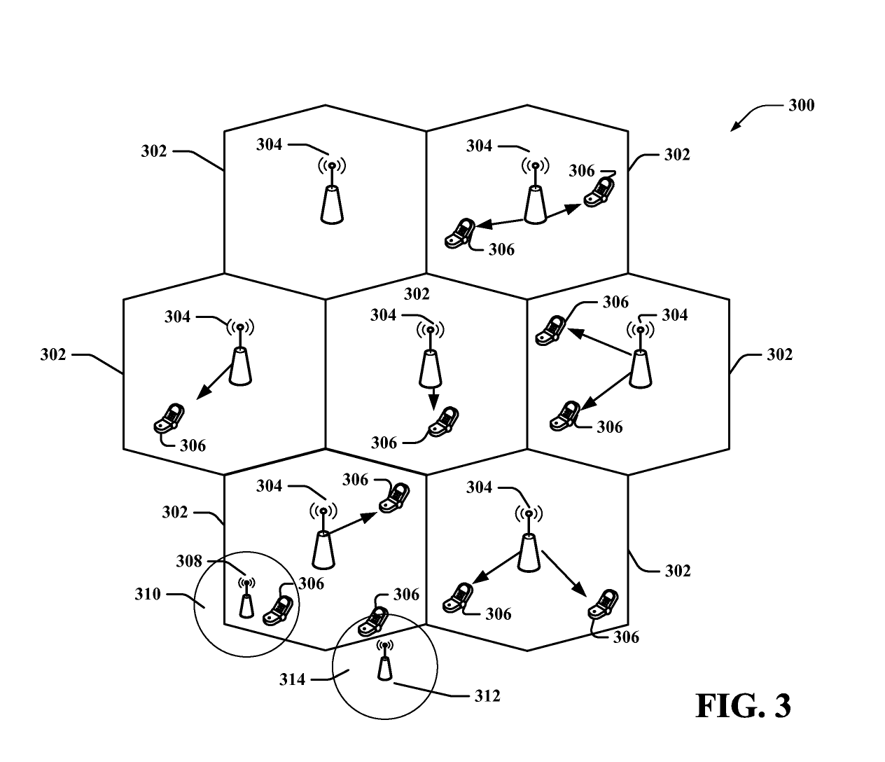

FIG. 3 is a diagram illustrating an example of an access network in an LTE network architecture. In this example, the access network 300 is divided into a number of cellular regions (cells) 302. One or more lower power class eNBs 308, 312 may have cellular regions 310, 314, respectively, that overlap with one or more of the cells 302. The lower power class eNBs 308, 312 may be femto cells (e.g., home eNBs (HeNBs)), pico cells, or micro cells. A higher power class or macro eNB 304 is assigned to a cell 302 and is configured to provide an access point to the EPC 210 for all the UEs 306 in the cell 302. There is no centralized controller in this example of an access network 300, but a centralized controller may be used in alternative configurations. The eNB 304 is responsible for all radio related functions including radio bearer control, admission control, mobility control, scheduling, security, and connectivity to the serving gateway 216 (see FIG. 2).

The modulation and multiple access scheme employed by the access network 300 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNB 304 may have multiple antennas supporting MIMO technology. The use of MIMO technology enables the eNB 304 to exploit the spatial domain to support spatial multiplexing, beamforming, and transmit diversity.

Spatial multiplexing may be used to transmit different streams of data simultaneously on the same frequency. The data steams may be transmitted to a single UE 306 to increase the data rate or to multiple UEs 306 to increase the overall system capacity. This is achieved by spatially precoding each data stream and then transmitting each spatially precoded stream through a different transmit antenna on the downlink. The spatially precoded data streams arrive at the UE(s) 306 with different spatial signatures, which enables each of the UE(s) 306 to recover the one or more data streams destined for that UE 306. On the uplink, each UE 306 transmits a spatially precoded data stream, which enables the eNB 304 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the downlink. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The uplink may use SC-FDMA in the form of a DFT-spread OFDM signal to compensate for high peak-to-average power ratio (PARR).

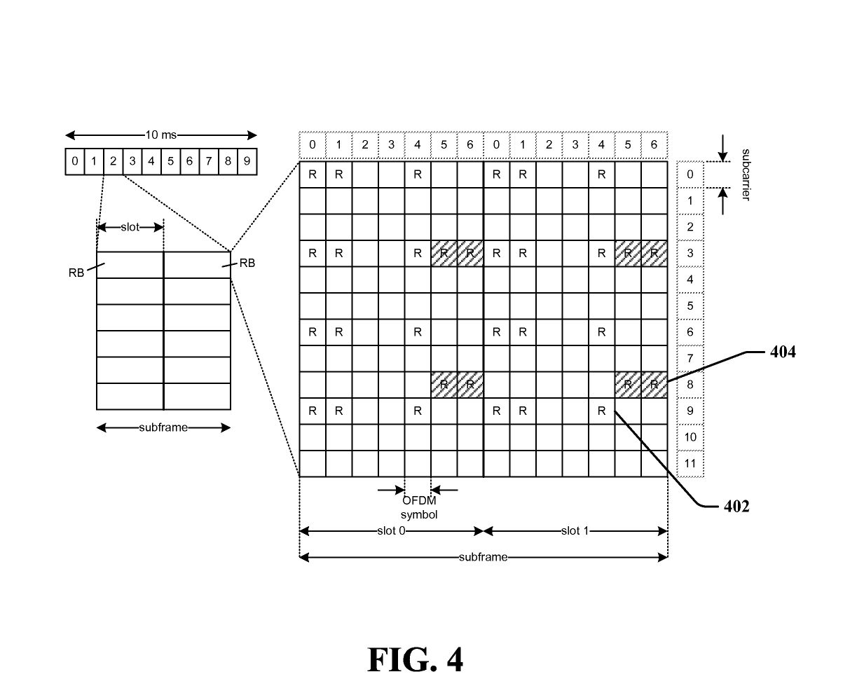

Various frame structures may be used to support the DL and UL transmissions. An example of a DL frame structure will now be presented with reference to FIG. 4. However, as those skilled in the art will readily appreciate, the frame structure for any particular application may be different depending on any number of factors. In this example, a frame (10 ms) is divided into 10 equally sized sub-frames. Each sub-frame includes two consecutive time slots.

A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. Some of the resource elements, as indicated as R 402, 404, include DL reference signals (DL-RS). The DL-RS include Cell-specific RS (CRS) (also sometimes called common RS) 402 and UE-specific RS (UE-RS) 404. UE-RS 404 are transmitted only on the resource blocks upon which the corresponding physical downlink shared channel (PDSCH) is mapped. The number of bits carried by each resource element depends on the modulation scheme. Thus, the more resource blocks that a UE receives and the higher the modulation scheme, the higher the data rate for the UE.

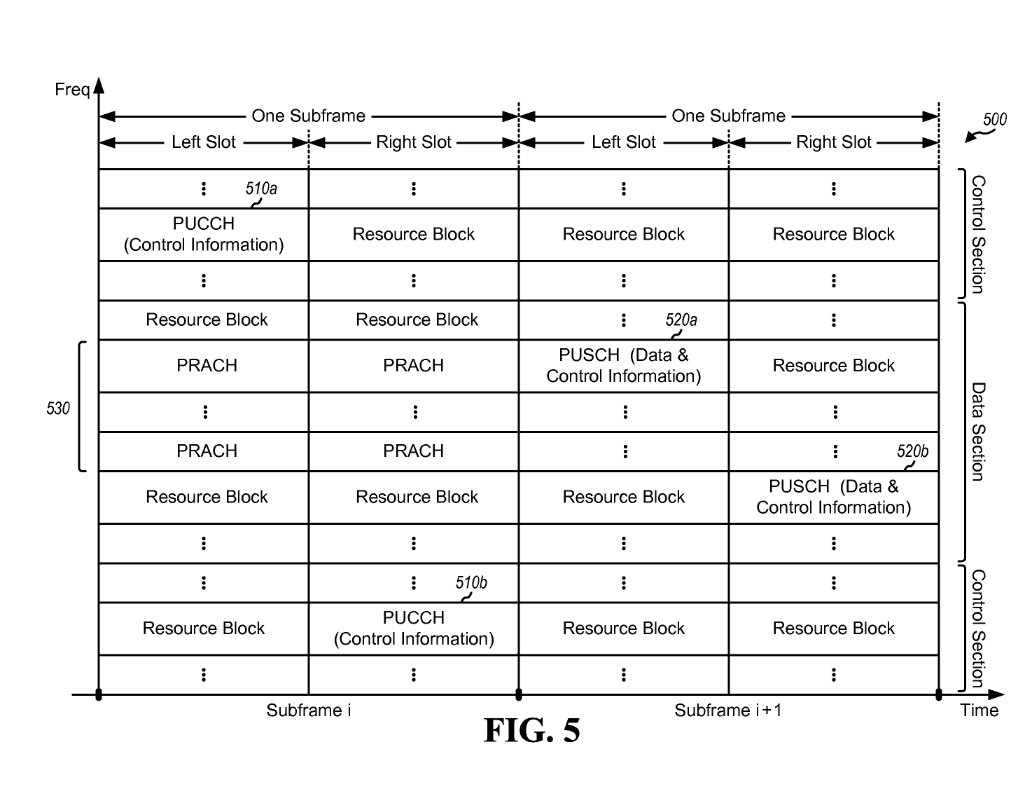

An example of a UL frame structure 500 will now be presented with reference to FIG. 5. FIG. 5 shows an exemplary format for the UL in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The design in FIG. 5 results in the data section including contiguous subcarriers, which may allow a single UE to be assigned all of the contiguous subcarriers in the data section.

A UE may be assigned resource blocks 510a, 510b in the control section to transmit control information to an eNB. The UE may also be assigned resource blocks 520a, 520b in the data section to transmit data to the eNB. The UE may transmit control information in a physical uplink control channel (PUCCH) on the assigned resource blocks in the control section. The UE may transmit only data or both data and control information in a physical uplink shared channel (PUSCH) on the assigned resource blocks in the data section. A UL transmission may span both slots of a subframe and may hop across frequency as shown in FIG. 5.

As shown in FIG. 5, a set of resource blocks may be used to perform initial system access and achieve UL synchronization in a physical random access channel (PRACH) 530. The PRACH 530 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) and a UE can make only a single PRACH attempt per frame (10 ms).

The PUCCH, PUSCH, and PRACH in LTE are described in 3GPP TS 36.211, entitled “Evolved Universal Terrestrial Radio Access (E-UTRA); Physical Channels and Modulation,” which is publicly available.

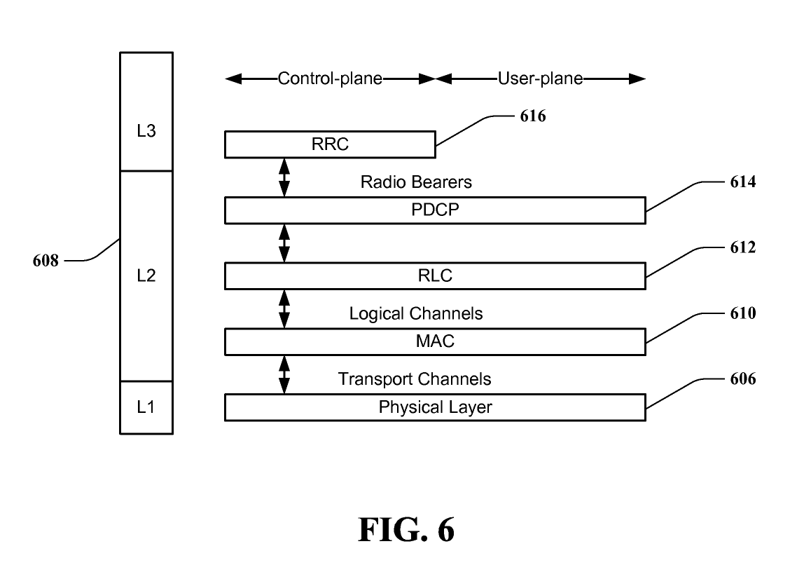

The radio protocol architecture may take on various forms depending on the particular application. An example for an LTE system will now be presented with reference to FIG. 6. FIG. 6 is a conceptual diagram illustrating an example of the radio protocol architecture for the user and control planes.

Turning to FIG. 6, the radio protocol architecture for the UE and the eNB is shown with three layers: Layer 1, Layer 2, and Layer 3. Layer 1 is the lowest layer and implements various physical layer signal processing functions. Layer 1 will be referred to herein as the physical layer 606. Layer 2 (L2 layer) 608 is above the physical layer 606 and is responsible for the link between the UE and eNB over the physical layer 606.

In the user plane, the L2 layer 608 includes a media access control (MAC) sublayer 610, a radio link control (RLC) sublayer 612, and a packet data convergence protocol (PDCP) 614 sublayer, which are terminated at the eNB on the network side. Although not shown, the UE may have several upper layers above the L2 layer 608 including a network layer (e.g., IP layer) that is terminated at the PDN gateway 208 (see FIG. 2) on the network side, and an application layer that is terminated at the other end of the connection (e.g., far end UE, server, etc.).

The PDCP sublayer 614 provides multiplexing between different radio bearers and logical channels. The PDCP sublayer 614 also provides header compression for upper layer data packets to reduce radio transmission overhead, security by ciphering the data packets, and handover support for UEs between eNBs. The RLC sublayer 612 provides segmentation and reassembly of upper layer data packets, retransmission of lost data packets, and reordering of data packets to compensate for out-of-order reception due to hybrid automatic repeat request (HARQ). The MAC sublayer 610 provides multiplexing between logical and transport channels. The MAC sublayer 610 is also responsible for allocating the various radio resources (e.g., resource blocks) in one cell among the UEs. The MAC sublayer 610 is also responsible for HARQ operations.

In the control plane, the radio protocol architecture for the UE and eNB is substantially the same for the physical layer 606 and the L2 layer 608 with the exception that there is no header compression function for the control plane. The control plane also includes a radio resource control (RRC) sublayer 616 in Layer 3. The RRC sublayer 616 is responsible for obtaining radio resources (i.e., radio bearers) and for configuring the lower layers using RRC signaling between the eNB and the UE.

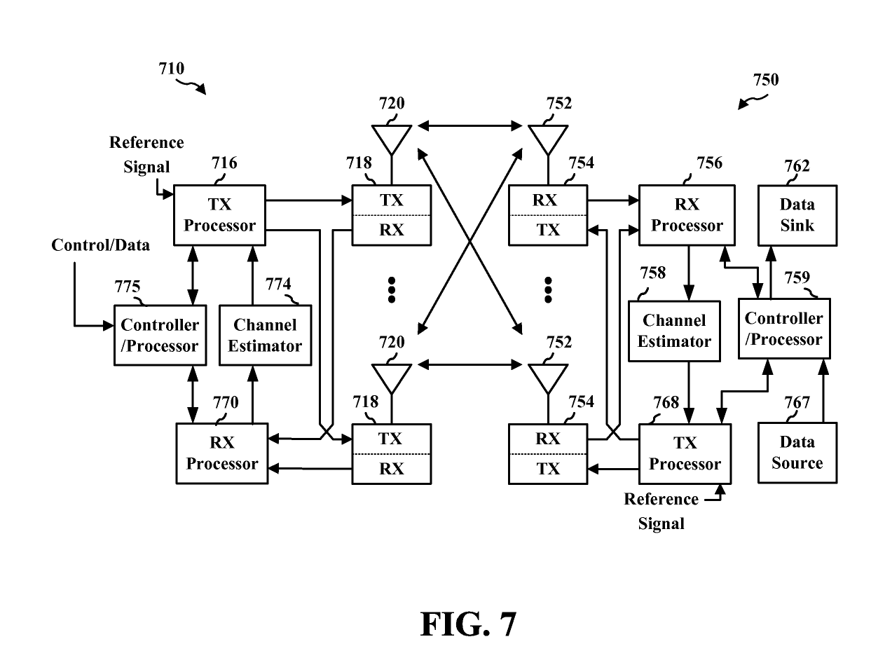

FIG. 7 is a block diagram of an eNB 710 in communication with a UE 750 in an access network. In the DL, upper layer packets from the core network are provided to a controller/processor 775. The controller/processor 775 implements the functionality of the L2 layer described earlier in connection with FIG. 6. In the DL, the controller/processor 775 provides header compression, ciphering, packet segmentation and reordering, multiplexing between logical and transport channels, and radio resource allocations to the UE 750 based on various priority metrics. The controller/processor 775 is also responsible for HARQ operations, retransmission of lost packets, and signaling to the UE 750.

The TX processor 716 implements various signal processing functions for the L1 layer (i.e., physical layer). The signal processing functions includes coding and interleaving to facilitate forward error correction (FEC) at the UE 750 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 774 may be used to determine the coding and modulation scheme, as well as for spatial processing. The channel estimate may be derived from a reference signal and/or channel condition feedback transmitted by the UE 750. Each spatial stream is then provided to a different antenna 720 via a separate transmitter 718TX. Each transmitter 718TX modulates an RF carrier with a respective spatial stream for transmission.

At the UE 750, each receiver 754RX receives a signal through its respective antenna 752. Each receiver 754RX recovers information modulated onto an RF carrier and provides the information to the receiver (RX) processor 756.

The RX processor 756 implements various signal processing functions of the L1 layer. The RX processor 756 performs spatial processing on the information to recover any spatial streams destined for the UE 750. If multiple spatial streams are destined for the UE 750, they may be combined by the RX processor 756 into a single OFDM symbol stream. The RX processor 756 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 710. These soft decisions may be based on channel estimates computed by the channel estimator 758. The soft decisions are then decoded and deinterleaved to recover the data and control signals that were originally transmitted by the eNB 710 on the physical channel. The data and control signals are then provided to the controller/processor 759.

The controller/processor 759 implements the L2 layer described earlier in connection with FIG. 6. In the UL, the controller/processor 759 provides demultiplexing between transport and logical channels, packet reassembly, deciphering, header decompression, control signal processing to recover upper layer packets from the core network. The upper layer packets are then provided to a data sink 762, which represents all the protocol layers above the L2 layer. Various control signals may also be provided to the data sink 762 for L3 processing. The controller/processor 759 is also responsible for error detection using an acknowledgement (ACK) and/or negative acknowledgement (NACK) protocol to support HARQ operations.

In the UL, a data source 767 is used to provide upper layer packets to the controller/processor 759. The data source 767 represents all protocol layers above the L2 layer (L2). Similar to the functionality described in connection with the DL transmission by the eNB 710, the controller/processor 759 implements the L2 layer for the user plane and the control plane by providing header compression, ciphering, packet segmentation and reordering, and multiplexing between logical and transport channels based on radio resource allocations by the eNB 710. The controller/processor 759 is also responsible for HARQ operations, retransmission of lost packets, and signaling to the eNB 710.

Channel estimates derived by a channel estimator 758 from a reference signal or feedback transmitted by the eNB 710 may be used by the TX processor 768 to select the appropriate coding and modulation schemes, and to facilitate spatial processing. The spatial streams generated by the TX processor 768 are provided to different antenna 752 via separate transmitters 754TX. Each transmitter 754TX modulates an RF carrier with a respective spatial stream for transmission.

The UL transmission is processed at the eNB 710 in a manner similar to that described in connection with the receiver function at the UE 750. Each receiver 718RX receives a signal through its respective antenna 720. Each receiver 718RX recovers information modulated onto an RF carrier and provides the information to a RX processor 770. The RX processor 770 implements the L1 layer.

The controller/processor 759 implements the L2 layer described earlier in connection with FIG. 6. In the UL, the controller/processor 759 provides demultiplexing between transport and logical channels, packet reassembly, deciphering, header decompression, control signal processing to recover upper layer packets from the UE 750. Upper layer packets from the controller/processor 775 may be provided to the core network. The controller/processor 759 is also responsible for error detection using an ACK and/or NACK protocol to support HARQ operations.

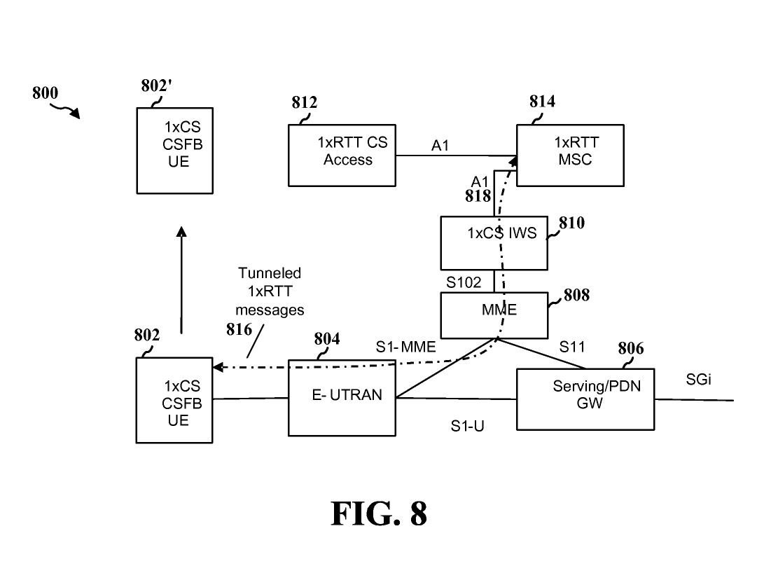

FIG. 8 is a reference architecture 800 for circuit switched (CS) fallback to CDMA 1×Radio Transmission Technology (RTT) CS. As shown in FIG. 8, the 1×CS circuit switched fallback (1×CSFB) UE 802 is coupled to the E-UTRAN 804. The E-UTRAN 804 is coupled to the Serving/PDN Gateway 806 through the S1-U interface. The Serving/PDN Gateway 806 is coupled to the Operator's IP Services 222 (see FIG. 2) through the SGi interface. The E-UTRAN 804 is coupled to the MME 808 through the S1-MME interface and the Serving/PDN Gateway 806 is coupled to the MME 808 through the S11 interface. The MME 808 is coupled to the 1×CS Interworking Solution (IWS) 810 through the S102 interface. The 1×CS IWS 810 is an interworking function for 3GPP2 1×CS. The 1×CS IWS 810 is coupled to the 1×RTT Mobile Switching Center (MSC) 814 through the A1 interface. The 1×RTT MSC 814 is coupled to the 1×RTT CS Access 812 through the A1 interface. The 1×CS IWS 810 is logically a 1×Base Station Controller (BSC).

The 1×RTT MSC 814 sends A1 messages 816 to the IWS 810. Then the IWS 810 generates corresponding 1×RTT messages and sends them to the 1×CSFB UE 802 over the tunnel. The IWS 810 receives tunneled 1×RTT messages from the 1×CSFB UE 802. Then, the IWS generates corresponding A1 messages and sends them to the 1×RTT MSC 814. The tunneled 1×RTT messages 816 are messages tunneled through the MME 808 and the E-UTRAN 804 between the 1×CSFB UE 802 and the IWS 810 for handling procedures related to the 1×CSFB to 1×RTT. The 1×CSFB to 1×RTT procedures, which include procedures for mobility management, mobile originated calls, and mobile terminated calls, are defined in 3GPP TS 23.272, entitled “3^{rd} Generation Partnership Project (3GPP); Technical Specification (TS) Group Services and System Aspects; Circuit Switched (CS) fallback in Evolved Packet System (EPS); Stage 2.”

The CS fallback for 1×RTT in EPS enables the delivery of CS-domain services, such as for example, CS voice and Short Message Service (SMS) by reuse of the 1×CS infrastructure (812, 814) when the UE 802 is served by the E-UTRAN. The CS fallback enables carriers to use their existing 2G/3G networks for voice calls and SMS, while deploying LTE for mobile broadband. A CS fallback enabled UE, while connected to the E-UTRAN may register in the 1×RTT CS domain in order to be able to use 1×RTT access to establish one or more CS services in the CS domain. The CS fallback function is only available where E-UTRAN coverage overlaps with 1×RTT coverage. The CS fallback option implements mechanisms to “redirect” UE originated and UE terminated calls to legacy CS systems when the UE 802 is camped or active on LTE. For a UE terminated call, the US 802 would be paged for an incoming CS voice call via a paging message. The UE 802 would switch radio technologies (shown as UE 802′) to receive the call. A similar switch would occur for a UE originated voice or SMS call if a short message is supposed to be delivered over the 1×traffic channel.

The 1×CS CSFB UE 802, in addition to supporting access to the E-UTRAN 804 and EPC (i.e., Serving/PDN Gateway 806 and MME 808), must support access to the 1×CS domain over 1×RTT. Furthermore, the 1×CSFB UE 802 supports the following additional functions: 1×RTT CS registration over the EPS after the UE has completed the E-UTRAN attachment; 1×RTT CS re-registration due to mobility; CS fallback procedures specified for 1×RTT CS domain voice service if a voice service is provided by 1×CSFB; and procedures for mobile originated and mobile terminated SMS tunneled over EPS and S102 if an SMS is provided over S102 interface. The 1×CSFB procedures may include enhanced CS fallback to 1×RTT capability indication as part of the UE capabilities, and may include concurrent 1×RTT and high rate packet data (HRPD) capability indication as part of the UE radio capabilities if supported by enhanced CS fallback to 1×RTT capable UE.

For 1×CSFB, the MME 808 supports the following additional functions: serves as a signaling tunneling end point towards the 3GPP2 1×IWS 810 via the S102 interface for sending/receiving encapsulated 3GPP2 1×CS signaling messages to/from the UE 802, 1×CS IWS 810 selection for CSFB procedures, handing of S102 tunnel redirection in case of MME relocation, and buffering of messages received via S102 for UEs in the idle state. In addition, the E-UTRAN 804 enabled for 1×CSFB supports the following additional functions: provision of control information that causes the UE to trigger 1×CS registration, forwarding the 1×RTT CS paging request to the UE, forwarding the 1×RTT CS related messages between the MME 808 and the UE 802, release of the E-UTRAN resources after the UE 802 leaves the E-UTRAN coverage subsequent to a page for CS fallback to 1×RTT CS if PS handover is not performed in conjunction with 1×CS fallback, and invoking the optimized or non-optimized PS handover procedure concurrently with enhanced 1×CS fallback procedure when supported by the network and the UE.

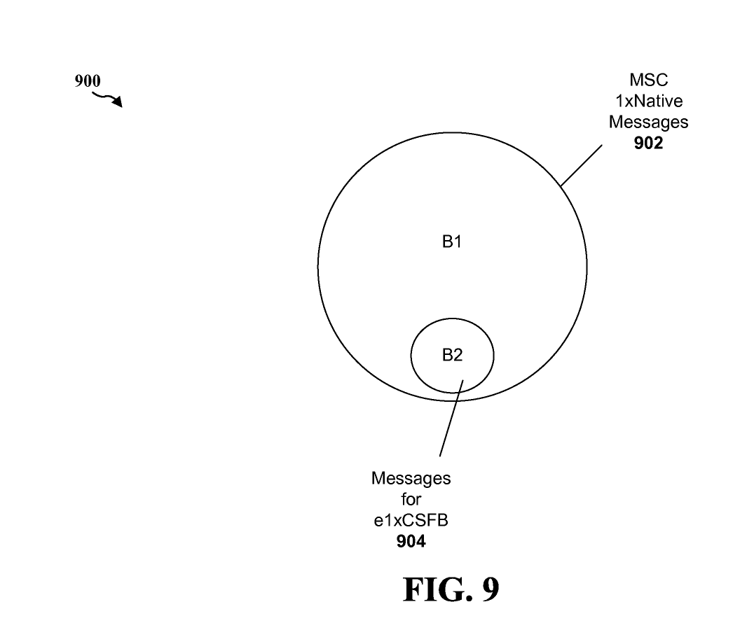

FIG. 9 is an illustration 900 showing the sets of messages for 1×native operation 902 and messages for enhanced 1×CSFB (e1×CSFB) operation 904. The messages for 1×native operation 902 could include the following messages (more messages and orders can be found in 3GPP2 C.S0005-E.):
Orders
Lock Until Power Cycled, Maintenance Required or Unlock Orders
Abbreviated Alert Order
Registration Accepted Order, Registration Rejected Order, Registration Request Order
Audit Order
Base Station Acknowledgement Order
Base Station Challenge Confirmation Order
Reorder
Intercept Order
Release Order
Slotted Mode Order
Retry Order
Rel A Message—Base Station Reject Order
Rel D Message—Fast Call Setup Order
Mobile Station Reject Order
Base Station Challenge Order
SSD Update Confirmation/Rejection Order
Messages
Channel Assignment Message
Handoff Direction Message
TMSI Assignment Message
Feature Notification Message
Data Burst Message
Status Request Message
Authentication Challenge Message
Shared Secret Data (SSD) Update Message
Service Redirection Message
PACA Message
Rel A Message—Security Mode Command Message
Authentication Request Message
Page Message
Registration Message
Origination Message
Page Response Message
Authentication Challenge Response Message

The messages for e1×CSFB operation 904 could include the following messages. These are called “tunneled messages.”
Orders
Registration Accepted Order, Registration Rejected Order, Registration Request Order
Base Station Challenge Confirmation Order
Reorder
Release Order
Mobile Station Reject Order
Base Station Challenge Order
SSD Update Confirmation/Rejection Order
Messages
Channel Assignment Message
Handoff Direction Message
Data Burst Message
Authentication Challenge Message
Shared Secret Data (SSD) Update Message
Page Message
Registration Message
Origination Message
Page Response Message
Authentication Challenge Response Message

The 1×RTT MSC 814 is configured to send A1 messages for 1×native operation expecting the set B1 can be supported through the A1 interface 818 to the 1×CS IWS 810. However, LTE only supports the e1×CSFB messages 904 in the set B2. This could lead to problems. In order to address the problems, in a first configuration, the 1×RTT MSC 814 may be configured to filter some messages on the particular A1 interface (i.e., A1 interface 818) that is coupled to the 1×CS IWS 810. In such a configuration, the 1×RTT MSC 814 filters out A1 messages which trigger the generation of the set of messages B2^{C}—i.e., the complement of the set B2, which is the set of messages included in the set B1 that is not in the set B2. The 1×RTT MSC 814 may be notified by the 1×CS IWS 810 of messages that the 1×RTT MSC 814 should or should not send to the 1×CS IWS 810. The filtering may be an operations, administration, and management (OAM) based setting. Such a configuration would allow for only a subset of the messages for 1×native operation 902 to be supported.

In a second configuration, the 1×CS IWS 810 knows what kind of messages for 1×native operation 902 can be exchanged over the tunnel, and if the 1×CS IWS 810 receives an unsupported message (i.e., a message that would trigger the generation of a message in the set of messages B2^{C}) from the 1×RTT MSC 814, the 1×CS IWS 810 filters the unsupported message by silently discarding the unsupported message. The configuration may cause the 1×RTT MSC 814 to send the unsupported messages repeatedly. In a third configuration, the 1×CS IWS 810 filters the unsupported messages and the 1×RTT MSC 814 is configured to accommodate not receiving responses for some of the messages the 1×RTT MSC 814 sends. The 1×RTT MSC 814 accommodates not receiving responses by abstaining from sending a message when a response to unsupported messages is not received. In a fourth configuration, all messages that could possibly be sent from the 1×RTT MSC 814 while the 1×CS CSFB UE 802 is idle are supported. In such a configuration, the set B2 is equal to the set B1.

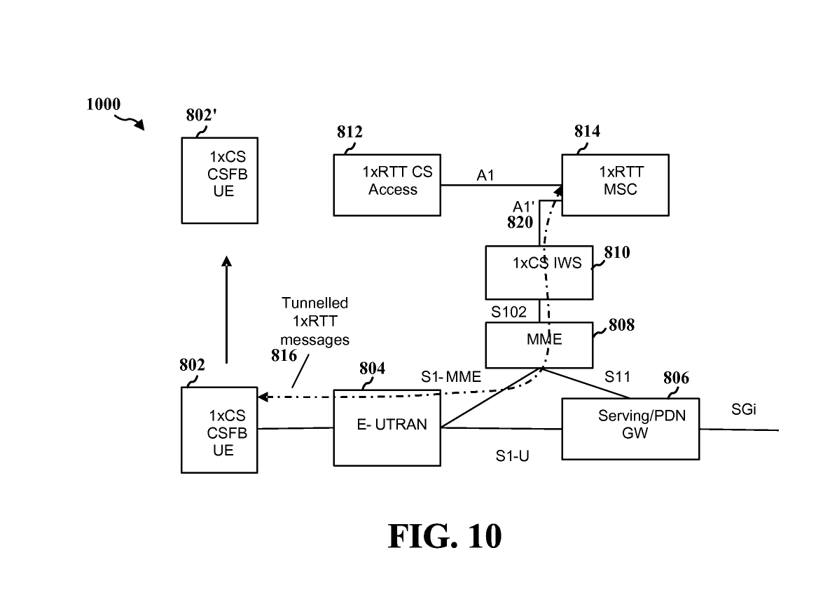

FIG. 10 is an exemplary architecture 1000 for CSFB to 1×RTT CS. In a fifth configuration, the 1×RTT MSC 814 has an interface A1′ 820 that is different from the interface A1 818 such that the 1×RTT MSC 814 may only send the subset of messages to the 1×CS IWS 810 that would trigger the generation of the set of messages B2. As is clear from the first through fifth configurations, the 1×RTT MSC 814 and/or the 1×CS IWS 810 must filter unsupported messages if the 1×RTT MSC 814 is configured to send such unsupported messages to the 1×CS IWS 810. The 1×RTT MSC 814 may also need to be aware of its role in the e1×CSFB messaging with the 1×CS IWS 810, either through sending only messages that are supported for the e1×CSFB procedures or through accommodating not receiving responses to the unsupported messages the 1×RTT MSC 814 sends.

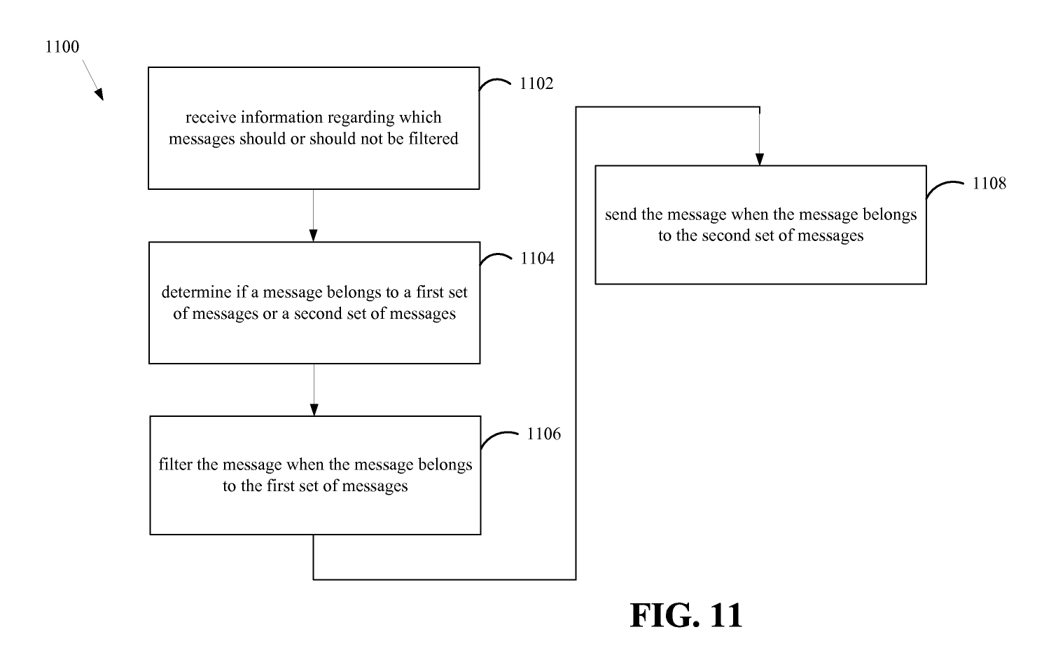

FIG. 11 is a flow chart 1100 of a method of wireless communication. The method is performed by the MSC 814 in which the MSC 814 performs filtering. In the method, the MSC 814 may receive information regarding which messages should or should not be filtered (1102). The MSC 814 determines if a message belongs to a first set of messages or a second set of messages (1104). The MSC 814 filters the message when the message belongs to the first set of messages (1106) and sends the message when the message belongs to the second set of messages (1108). In one configuration, the first set of messages includes messages unsupported by an apparatus coupled to the MSC and the second set of messages includes messages supported by the apparatus. The first set of messages corresponds to the set of messages that would trigger the generation of messages B2^{C} in the IWS and the second set of messages correspond to the set of messages that would trigger the generation of messages B2 in the IWS. In one configuration, the apparatus is an IWS and the unsupported messages are 1×native messages unsupported by the IWS for tunneling to a user equipment and the supported messages are 1×native messages supported by the IWS for tunneling to the user equipment for circuit switch fallback procedures. In one configuration, the information received in step 1102 is received from the IWS. In one configuration, the message is sent on an A1 interface.

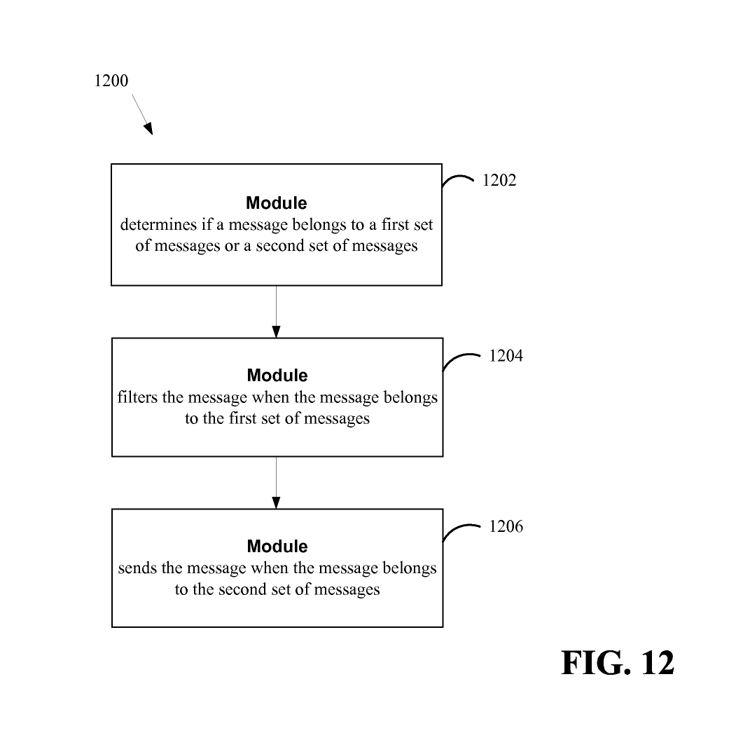

FIG. 12 is a conceptual block diagram 1200 illustrating the functionality of an exemplary apparatus 100. The apparatus 100 is an MSC 814 in which the MSC 814 performs filtering. The apparatus 100 includes a module 1202 that determines if a message belongs to a first set of messages or a second set of messages. In addition, the apparatus 100 includes a module 1204 that filters the message when the message belongs to the first set of messages and a module 1206 that sends the message when the message belongs to the second set of messages.

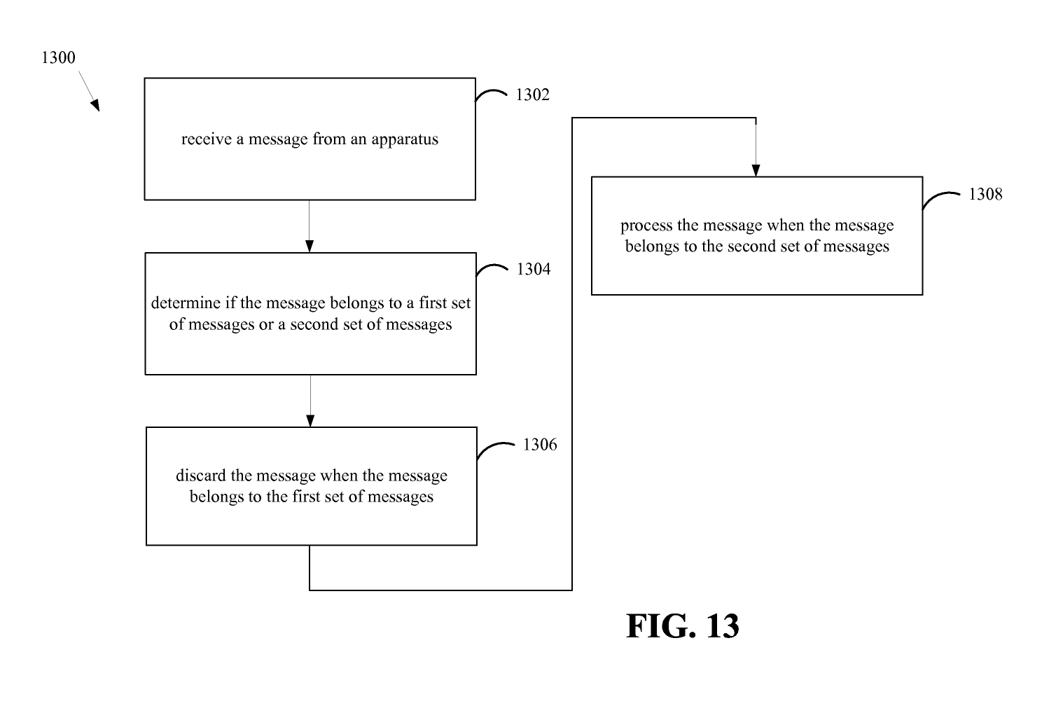

FIG. 13 is a flow chart 1300 of a method of wireless communication. The method is performed by the IWS 810 in which the IWS 810 discards some messages. In the method, the IWS 810 receives a message from an apparatus (1302). IWS 810 determines if the message belongs to a first set of messages or a second set of messages (1304). The IWS 810 discards the message when the message belongs to the first set of messages (1306). The IWS 810 may process the message when the message belongs to the second set of messages (1308). In one configuration, the message is received from an MSC. In one configuration, the first set of messages includes messages unsupported for tunneling to a user equipment for circuit switch fallback procedures and the second set of messages includes messages supported for tunneling to the user equipment for the circuit switch fallback procedures. In one configuration, the message is a message for 1×native operation received on an A1 interface.

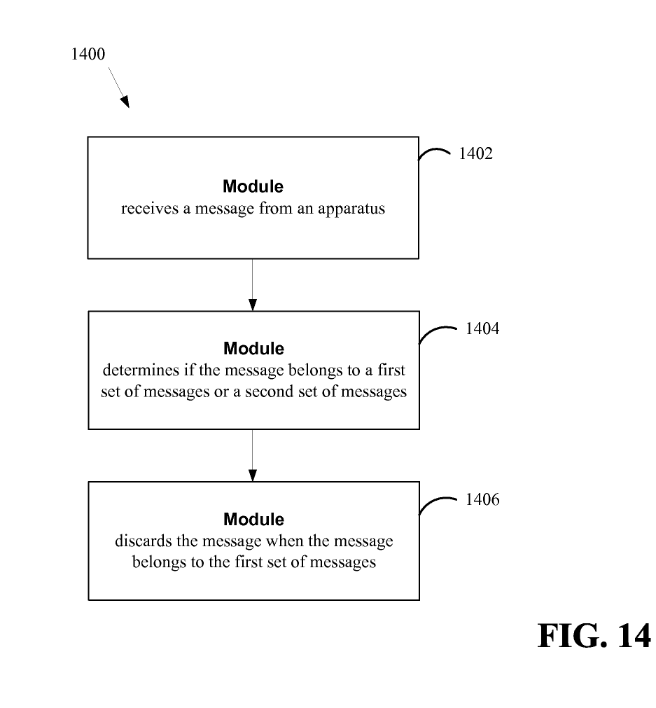

FIG. 14 is a conceptual block diagram 1400 illustrating the functionality of an exemplary apparatus 100. The apparatus 100 is an IWS 810 in which the IWS 810 discards some messages. The apparatus 100 includes a module 1402 that receives a message from an apparatus. In addition, the apparatus 100 includes a module 1404 that determines if the message belongs to a first set of messages or a second set of messages. Furthermore, the apparatus 100 includes a module 1406 that discards the message when the message belongs to the first set of messages.

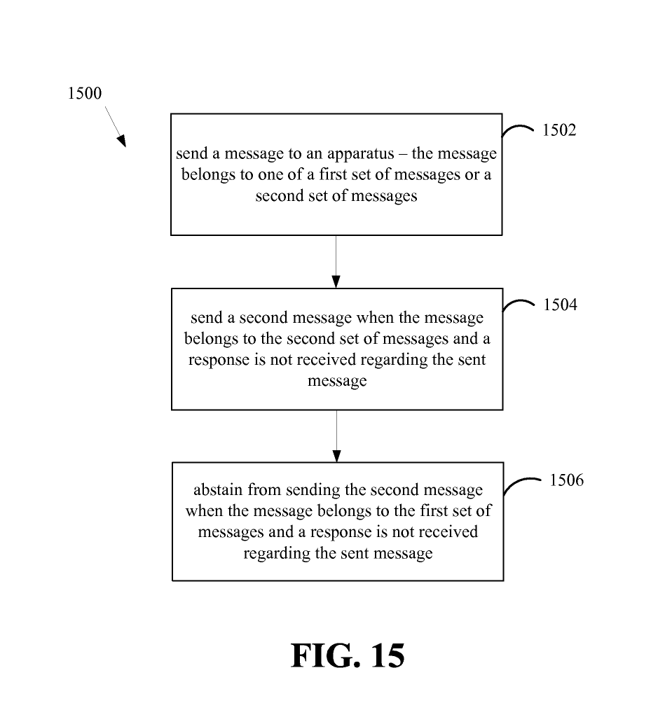

FIG. 15 is a flow chart 1500 of a method of wireless communication. The method is performed by the MSC 814 in which the MSC 814 accommodates not receiving responses when the IWS 810 discards some messages. In the method, the MSC 814 sends a message to an apparatus (1502). The message belongs to one of a first set of messages or a second set of messages (1502). In addition, the MSC 814 sends a second message when the message belongs to the second set of messages and a response is not received regarding the sent message (1504). Furthermore, the MSC 814 abstains from sending the second message when the message belongs to the first set of messages and a response is not received regarding the sent message (1506). In one configuration, the message is for tunneling to a UE. In one configuration, the apparatus is the IWS 810. In one configuration, the message is any message for 1×native operation supported by an A1 interface.

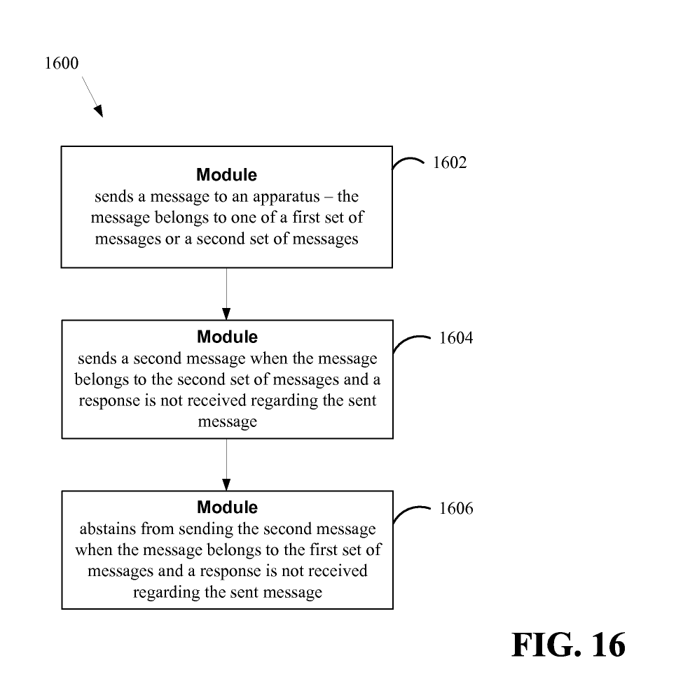

FIG. 16 is a conceptual block diagram 1600 illustrating the functionality of an exemplary apparatus 100. The apparatus 100 is the MSC 814 in which the MSC 814 accommodates not receiving responses when the IWS 810 discards some messages. The apparatus 100 includes a module 1602 that sends a message to an apparatus. The message belongs to one of a first set of messages or a second set of messages. In addition, the apparatus 100 includes a module 1604 that sends a second message when the message belongs to the second set of messages and a response is not received regarding the sent message. Furthermore, the apparatus 100 includes a module 1606 that abstains from sending the second message when the message belongs to the first set of messages and a response is not received regarding the sent message.

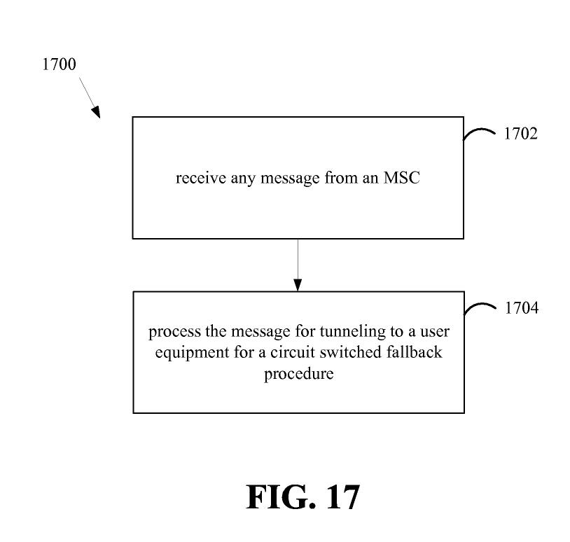

FIG. 17 is a flow chart 1700 of a method of wireless communication. The method is performed by the IWS 810 in which the IWS 810 supports all possible messages for 1×native operation through the A1 interface. In the method, the IWS 810 receives any message from the MSC 814 (1702) and processes the message for tunneling to a user equipment for a circuit switched fallback procedure (1704). The message may be any message for 1×native operation supported on an A1 interface.

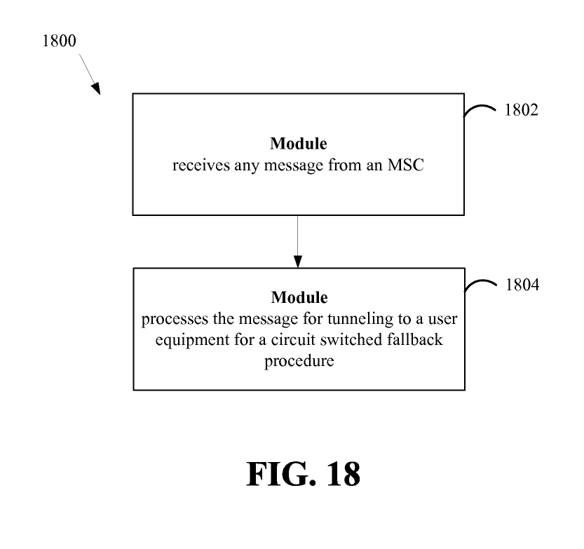

FIG. 18 is a conceptual block diagram 1800 illustrating the functionality of an exemplary apparatus 100. The apparatus 100 is the IWS 810 in which the IWS 810 supports all possible messages for 1×native operation through the A1 interface. The apparatus 100 includes a module 1802 that receives any message from the MSC 814 and a module 1804 that processes the message for tunneling to a user equipment for a circuit switched fallback procedure.

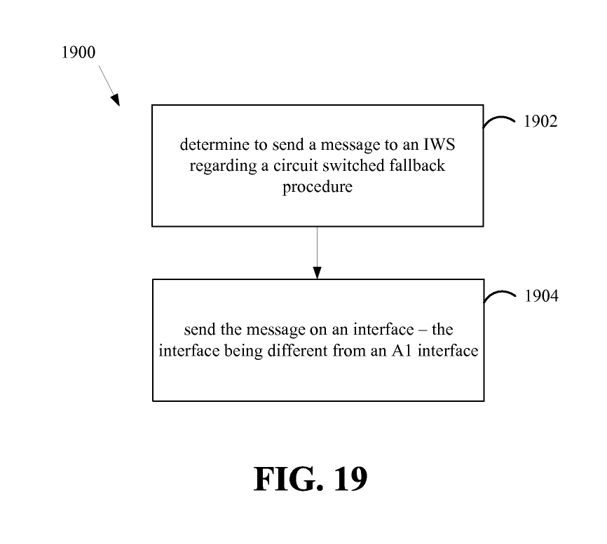

FIG. 19 is a flow chart 1900 of a method of wireless communication. The method is performed by the MSC 814 in which the MSC 814 has an interface A1′ to the IWS 810 that supports only 1×messages for 1×CSFB procedures. In the method, the MSC 814 determines to send a message to the IWS 810 regarding a circuit switched fallback procedure (1902). In addition, the MSC 814 send the message on an interface A1′ (1904). The interface A1′ is different from the A1 interface (1904). The interface A1′ includes only a subset of messages supported by the A1 interface and corresponds to only the set of messages that would trigger generation of the set of messages B2 in the IWS 810. In one configuration, the message is a 1×native message for tunneling to a UE. In one configuration, the interface A1′ supports only tunneled messages for circuit switched fallback procedures.

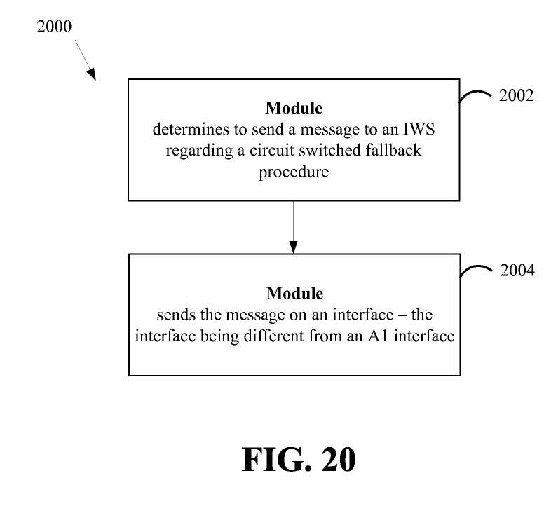

FIG. 20 is a conceptual block diagram 2000 illustrating the functionality of an exemplary apparatus 100. The apparatus 100 is the MSC 814 in which the MSC 814 has an interface A1′ to the IWS 810 that supports only 1×messages for 1×CSFB procedures. The apparatus 100 includes a module 2002 that determines to send a message to the IWS 810 regarding a circuit switched fallback procedure. In addition, the apparatus 100 includes a module 2004 that sends the message on an interface A1′. The interface A1′ is different from the A1 interface.

Referring to FIG. 1, in one configuration, the apparatus 100, which may be an MSC, includes means for means for determining if a message belongs to a first set of messages or a second set of messages, means for filtering the message when the message belongs to the first set of messages, and means for sending the message when the message belongs to the second set of messages. The apparatus 100 may further include means for receiving information regarding which messages should or should not be filtered. The aforementioned means is the processing system 114 of the MSC configured to perform the functions recited by the aforementioned means.

In one configuration, the apparatus 100, which may be an IWS, includes means for receiving a message from an apparatus, means for determining if the message belongs to a first set of messages or a second set of messages, and means for discarding the message when the message belongs to the first set of messages. The apparatus 100 may further include means for processing the message when the message belongs to the second set of messages. The aforementioned means is the processing system 114 of the IWS configured to perform the functions recited by the aforementioned means.

In one configuration, the apparatus 100, which may be an MSC, includes means for sending a message to an apparatus. The message belongs to one of a first set of messages or a second set of messages. In addition, the apparatus 100 includes means for sending a second message when the message belongs to the second set of messages and a response is not received regarding the sent message, and means for abstaining from sending the second message when the message belongs to the first set of messages and a response is not received regarding the sent message. The aforementioned means is the processing system 114 of the MSC configured to perform the functions recited by the aforementioned means.

In one configuration, the apparatus 100, which may be an IWS, includes means for receiving any message from an MSC, and means for processing the message for tunneling to a user equipment for a circuit switched fallback procedure. The aforementioned means is the processing system 114 of the IWS configured to perform the functions recited by the aforementioned means.

In one configuration, the apparatus 100, which may be an MSC, includes means for determining to send a message to an IWS regarding a circuit switched fallback procedure, and means for sending the message on an interface, the interface being different from an A1 interface. The aforementioned means is the processing system 114 of the MSC configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of a mobile switching center (MSC), comprising:
determining if a message belongs to a first set of messages or a second set of messages;
filtering the message when the message belongs to the first set of messages; and
sending the message when the message belongs to the second set of messages.

2. The method of claim 1, wherein the first set of messages includes messages unsupported by an apparatus coupled to the MSC and the second set of messages includes messages supported by the apparatus.

3. The method of claim 2, wherein the apparatus is an interworking solution (IWS) and the unsupported messages are 1×native messages unsupported by the IWS for tunneling to a user equipment and the supported messages are 1×native messages supported by the IWS for tunneling to the user equipment for circuit switch fallback procedures.

4. The method of claim 1, further comprising receiving information regarding which messages should or should not be filtered.

5. The method of claim 4, wherein the information is received from a coupled interworking solution (IWS).

6. The method of claim 1, wherein the message is sent on an A1 interface.

7. A method of an interworking solution (IWS), comprising:
receiving a message from an apparatus;
determining if the message belongs to a first set of messages or a second set of messages; and
discarding the message when the message belongs to the first set of messages.

8. The method of claim 7, wherein the message is received from a mobile switching center (MSC).

9. The method of claim 7, further comprising processing the message when the message belongs to the second set of messages.

10. The method of claim 7, wherein the first set of messages includes messages unsupported for tunneling to a user equipment for circuit switch fallback procedures and the second set of messages includes messages supported for tunneling to the user equipment for the circuit switch fallback procedures.

11. The method of claim 7, wherein the message is a message for 1×native operation received on an A1 interface.

12. A method of a mobile switching center (MSC), comprising:
sending a message to an apparatus, the message belonging to one of a first set of messages or a second set of messages;
sending a second message when the message belongs to the second set of messages and a response is not received regarding the sent message; and
abstaining from sending the second message when the message belongs to the first set of messages and a response is not received regarding the sent message.

13. The method of claim 12, wherein the message is for tunneling to a user equipment.

14. The method of claim 12, wherein the apparatus is an interworking solution (IWS).

15. The method of claim 12, wherein the message is any message for 1×native operation supported by an A1 interface.

16. A method of an interworking solution (IWS), comprising:
receiving any message from a mobile switching center (MSC); and
processing the message for tunneling to a user equipment for a circuit switched fallback procedure.

17. The method of claim 16, wherein the message is any message for 1×native operation supported on an A1 interface.

18. A method of a mobile switching center (MSC), comprising:
determining to send a message to an interworking solution (IWS) regarding a circuit switched fallback procedure; and
sending the message on an interface, the interface being different from an A1 interface.

19. The method of claim 18, wherein the message is a 1×native message for tunneling to a user equipment.

20. The method of claim 18, wherein the interface supports only tunneled messages for circuit switched fallback procedures.

21. A mobile switching center (MSC), comprising:
means for determining if a message belongs to a first set of messages or a second set of messages;
means for filtering the message when the message belongs to the first set of messages; and
means for sending the message when the message belongs to the second set of messages.

22. The MSC of claim 21, wherein the first set of messages includes messages unsupported by an apparatus coupled to the MSC and the second set of messages includes messages supported by the apparatus.

23. The MSC of claim 22, wherein the apparatus is an interworking solution (IWS) and the unsupported messages are 1×native messages unsupported by the IWS for tunneling to a user equipment and the supported messages are 1×native messages supported by the IWS for tunneling to the user equipment for circuit switch fallback procedures.

24. The MSC of claim 21, further comprising means for receiving information regarding which messages should or should not be filtered.

25. The MSC of claim 24, wherein the information is received from a coupled interworking solution (IWS).

26. The MSC of claim 21, wherein the message is sent on an A1 interface.

27. An interworking solution (IWS), comprising:
means for receiving a message from an apparatus;
means for determining if the message belongs to a first set of messages or a second set of messages; and
means for discarding the message when the message belongs to the first set of messages.

28. The IWS of claim 27, wherein the message is received from a mobile switching center (MSC).

29. The IWS of claim 27, further comprising means for processing the message when the message belongs to the second set of messages.

30. The IWS of claim 27, wherein the first set of messages includes messages unsupported for tunneling to a user equipment for circuit switch fallback procedures and the second set of messages includes messages supported for tunneling to the user equipment for the circuit switch fallback procedures.

31. The IWS of claim 27, wherein the message is a message for 1×native operation received on an A1 interface.

32. A mobile switching center (MSC), comprising:
means for sending a message to an apparatus, the message belonging to one of a first set of messages or a second set of messages;
means for sending a second message when the message belongs to the second set of messages and a response is not received regarding the sent message; and
means for abstaining from sending the second message when the message belongs to the first set of messages and a response is not received regarding the sent message.

33. The MSC of claim 32, wherein the message is for tunneling to a user equipment.

34. The MSC of claim 32, wherein the apparatus is an interworking solution (IWS).

35. The MSC of claim 32, wherein the message is any message for 1×native operation supported by an A1 interface.

36. An interworking solution (IWS), comprising:
means for receiving any message from a mobile switching center (MSC); and
means for processing the message for tunneling to a user equipment for a circuit switched fallback procedure.

37. The IWS of claim 36, wherein the message is any message for 1×native operation supported on an A1 interface.

38. A mobile switching center (MSC), comprising:
means for determining to send a message to an interworking solution (IWS) regarding a circuit switched fallback procedure; and
means for sending the message on an interface, the interface being different from an A1 interface.

39. The MSC of claim 38, wherein the message is a 1×native message for tunneling to a user equipment.

40. The MSC of claim 38, wherein the interface supports only tunneled messages for circuit switched fallback procedures.

41. A computer program product of a mobile switching center (MSC), comprising:
a computer-readable medium comprising code for:
determining if a message belongs to a first set of messages or a second set of messages;
filtering the message when the message belongs to the first set of messages; and
sending the message when the message belongs to the second set of messages.

42. The computer program product of claim 41, wherein the first set of messages includes messages unsupported by an apparatus coupled to the MSC and the second set of messages includes messages supported by the apparatus.

43. The computer program product of claim 42, wherein the apparatus is an interworking solution (IWS) and the unsupported messages are 1×native messages unsupported by the IWS for tunneling to a user equipment and the supported messages are 1×native messages supported by the IWS for tunneling to the user equipment for circuit switch fallback procedures.

44. The computer program product of claim 41, wherein the computer-readable medium further comprises code for receiving information regarding which messages should or should not be filtered.

45. The computer program product of claim 44, wherein the information is received from a coupled interworking solution (IWS).

46. The computer program product of claim 41, wherein the message is sent on an A1 interface.

47. A computer program product of an interworking solution (IWS), comprising:
a computer-readable medium comprising code for:
receiving a message from an apparatus;
determining if the message belongs to a first set of messages or a second set of messages; and
discarding the message when the message belongs to the first set of messages.

48. The computer program product of claim 47, wherein the message is received from a mobile switching center (MSC).

49. The computer program product of claim 47, wherein the computer-readable medium further comprises code for processing the message when the message belongs to the second set of messages.

50. The computer program product of claim 47, wherein the first set of messages includes messages unsupported for tunneling to a user equipment for circuit switch fallback procedures and the second set of messages includes messages supported for tunneling to the user equipment for the circuit switch fallback procedures.

51. The computer program product of claim 47, wherein the message is a message for 1×native operation received on an A1 interface.

52. A computer program product of a mobile switching center (MSC), comprising:
a computer-readable medium comprising code for:
sending a message to an apparatus, the message belonging to one of a first set of messages or a second set of messages;
sending a second message when the message belongs to the second set of messages and a response is not received regarding the sent message; and
abstaining from sending the second message when the message belongs to the first set of messages and a response is not received regarding the sent message.

53. The computer program product of claim 52, wherein the message is for tunneling to a user equipment.

54. The computer program product of claim 52, wherein the apparatus is an interworking solution (IWS).

55. The computer program product of claim 52, wherein the message is any message for 1×native operation supported by an A1 interface.

56. A computer program product of an interworking solution (IWS), comprising:
a computer-readable medium comprising code for:
receiving any message from a mobile switching center (MSC); and
processing the message for tunneling to a user equipment for a circuit switched fallback procedure.

57. The computer program product of claim 56, wherein the message is any message for 1×native operation supported on an A1 interface.

58. A computer program product of a mobile switching center (MSC), comprising:
a computer-readable medium comprising code for:
determining to send a message to an interworking solution (IWS) regarding a circuit switched fallback procedure; and
sending the message on an interface, the interface being different from an A1 interface.

59. The computer program product of claim 58, wherein the message is a 1×native message for tunneling to a user equipment.

60. The computer program product of claim 58, wherein the interface supports only tunneled messages for circuit switched fallback procedures.

61. A mobile switching center (MSC), comprising:
a processing system configured to:
determine if a message belongs to a first set of messages or a second set of messages;
filter the message when the message belongs to the first set of messages; and
send the message when the message belongs to the second set of messages.

62. The MSC of claim 61, wherein the first set of messages includes messages unsupported by an apparatus coupled to the MSC and the second set of messages includes messages supported by the apparatus.

63. The MSC of claim 62, wherein the apparatus is an interworking solution (IWS) and the unsupported messages are 1×native messages unsupported by the IWS for tunneling to a user equipment and the supported messages are 1×native messages supported by the IWS for tunneling to the user equipment for circuit switch fallback procedures.

64. The MSC of claim 61, wherein the processing system is further configured to receive information regarding which messages should or should not be filtered.

65. The MSC of claim 64, wherein the information is received from a coupled interworking solution (IWS).

66. The MSC of claim 61, wherein the message is sent on an A1 interface.

67. An interworking solution (IWS), comprising:
a processing system configured to:
receive a message from an apparatus;
determine if the message belongs to a first set of messages or a second set of messages; and
discard the message when the message belongs to the first set of messages.

68. The IWS of claim 67, wherein the message is received from a mobile switching center (MSC).

69. The IWS of claim 67, wherein the processing system is further configured to process the message when the message belongs to the second set of messages.

70. The IWS of claim 67, wherein the first set of messages includes messages unsupported for tunneling to a user equipment for circuit switch fallback procedures and the second set of messages includes messages supported for tunneling to the user equipment for the circuit switch fallback procedures.

71. The IWS of claim 67, wherein the message is a message for 1×native operation received on an A1 interface.

72. A mobile switching center (MSC), comprising:
a processing system configured to:
send a message to an apparatus, the message belonging to one of a first set of messages or a second set of messages;
send a second message when the message belongs to the second set of messages and a response is not received regarding the sent message; and
abstain from sending the second message when the message belongs to the first set of messages and a response is not received regarding the sent message.

73. The MSC of claim 72, wherein the message is for tunneling to a user equipment.

74. The MSC of claim 72, wherein the apparatus is an interworking solution (IWS).

75. The MSC of claim 72, wherein the message is any message for 1×native operation supported by an A1 interface.

76. An interworking solution (IWS), comprising:
a processing system configured to:
receive any message from a mobile switching center (MSC); and
process the message for tunneling to a user equipment for a circuit switched fallback procedure.

77. The IWS of claim 76, wherein the message is any message for 1×native operation supported on an A1 interface.

78. A mobile switching center (MSC), comprising:
a processing system configured to:
determine to send a message to an interworking solution (IWS) regarding a circuit switched fallback procedure; and
send the message on an interface, the interface being different from an A1 interface.

79. The MSC of claim 78, wherein the message is a 1×native message for tunneling to a user equipment.

80. The MSC of claim 78, wherein the interface supports only tunneled messages for circuit switched fallback procedures.
